(19) United States
(12) Patent Application Publication
(10) Pub. No.: US 2008/0281703 A1
(43) Pub. Date: Nov. 13, 2008

(54) Method of digital customer service and system thereof

(76) Inventor: Chih-Chen Wu, Pingtung City (TW)

Correspondence Address: Stanley P. Fisher;REED SMITH LLP, Suite 1400, 3110 Fairview Park Drive, Falls Church, VA, 22042, US

(21) Appl. No.: 11/882,821

(22) Filed: Aug. 6, 2007

(30) Foreign Application Priority Data
May 9, 2007 (TW) 096116526

(51) Int. Cl. G06Q 30/00

(52) U.S. Cl. 705/14

(57) ABSTRACT

A method of digital customer service and a system thereof are provide, which includes a network server machine, an identification (ID) sensing device, a display device, a merchandise sensing device, and a media playing device. The method is to sense a customer ID card via the ID sensing device, and then the network server machine accesses and outputs corresponding customer and consuming information, so as to output a specific greeting and advertising information based on the consuming information and requirements and display them in the display device. The merchandise sensing device is utilized to sense a merchandise label and then a corresponding advertisement is automatically played by the media playing device for promotion. Therefore, customers can find their favorite merchandises immediately after they enter the stores and the marketing media can help sales clerks to introduce merchandises and increase their knowledge about the merchandises, so as to increase service quality.

This application claims the benefit of Taiwan Patent Application No. 096116526, filed on May 9, 2007, which is hereby incorporated by reference for all purposes as if fully set forth herein.

### BACKGROUND OF THE INVENTION

1. Field of Invention

The present invention relates to a service method and system thereof, especially for a service method of digital service and a system thereof.

2. Related Art

In general, stores may install an image playing device in front of the door or inside the stores to play different advertising pictures, image media or voice media to present current promotions, discount activities, or new arrivals information of the stores, via this kind of dazzling image effect and agitative wording to attract customers to buy merchandise/goods. However, most of stores may install a sensor and beeper system on the door in case the sales clerks are too busy to see customers enter the store. The sensor is utilized to sense the entry of customers and then send out a greeting voice by the beeper, for instance, the sound of “Welcome” and so on. Besides, in order to avoid sales clerks can't fully answer customer queries or well introduce the merchandise to customers due to their lack of expertise on merchandise information; normally, the sales clerks would be instructed with relevant expertise or multiple training courses to let the sales clerks can familiar with the information of new arrivals.

However, conventional art has inevitable shortcoming, of which advertising pictures, image media or voice media for promotions, discount activities, or new arrivals information may not satisfy the customers' interest and demand. Therefore, the desire to buy merchandise from customers is quite limited. For instance, a customer is fond of miniskirt, however advertising pictures, image media, or voice media played in the store is related to sweater, which is not only unable to meet customers' interest and desire to buy the merchandise in the store, but even attract them to enter the store to look around.

Moreover, although stores may install a sensor and beeper system on the door to sense customers' entry and then to send out a voice file to greet the customers via the beeper, however, the voice from every beepers is no different, and the sensor and beeper system is unable to identify customers' identification and send out the greeting in their names, thus, the effect of the sensor and beeper system is merely to alert sales clerks that customers are entry. Nevertheless, sometimes sales clerks are all busy or servicing other customers, no other sales clerk is available to answer a customer without accompanied by sales clerk about his/her queries, so that the circumstance of inattentive service due to customer's long time waiting may occur.

In addition, although stores may have training courses for sales clerks, yet the training courses for new sales clerks are normally conducted by senior sales clerks based on their experiences, so that the circumstance of inconsistent quality of service among sales clerks may occur. Moreover, the sales clerks on duty may be all new recruited; therefore, customers may not fully understand or get incomplete information of merchandise from the sales clerks due to sales clerks' lack of expertise or inarticulate explanations, so as to affect sales and the impression of the store.

### SUMMARY OF THE INVENTION

In view of the above problems, an object of the present invention is to provide a method of digital service and a system thereof.

According to one embodiment of the present invention, a method of digital service is provided, which comprises the steps as follow.

Firstly, an identification (ID) sensing device is utilized to sense a customer identification (ID) card in a customer and then output the customer's data of the customer ID card as well as analyze the customer's data, so as to access the corresponding customer information and consuming information. Then according to the customer information, specific greeting information for the customer is sent out. Next, according to the consuming information, corresponding consuming records or advertising information is displayed to the customer. Secondly, merchandise labels can also be sensed to output merchandise data of merchandise, and the corresponding information will be searched from the network server machine and then a corresponding marketing media file is played accordingly.

An embodiment of the present invention is to provide a system of digital service, the system of digital service comprises an ID sensing device, a merchandise sensing device, a network server machine, a display device and a media playing device. The network server machine comprises at least a network server database and the network server machine is connected to the ID sensing device, the merchandise sensing device, the display device and the media playing device. The ID sensing device is utilized to sense a customer ID card and then to output the customer's data of the card to the network server machine. The network server machine analyzes the customer's data and then accesses corresponding customer's information as well as consuming information from the network server database. Then, according to the customer's information, specific greeting information is sent out by the network server machine, meanwhile, the customized advertising information is outputted according to the customer's consuming information, and then the greeting and advertising information is displayed and played by the display device and the playing device respectively. Also, the merchandise sensing device is utilized to sense a merchandise label and then to output the merchandise data of the label to the network server machine. The network server machine analyzes the merchandise data and then outputs a corresponding marketing media file accordingly from the network server database, and then the market media file is played by the media playing device. The marketing media file may be an image medium and/or a voice one.

Besides, the service system of the present invention further comprises a speaker device, whenever the network server machine outputs the specific greeting information and the advertising information, the voice media files of the greeting and advertising information are outputted parallel and being performed via the speaker device.

In addition, the present invention can achieve the effects, which are not achievable in prior art; that is, when customers are close to the store, their identification can be identified by a magnetic card, and a media playing device is utilized to send out a specific greeting wording for the customer. Besides, a display device is utilized to show advertising information of the customer's favorite merchandise as well as to play a voice media file of corresponding advertising information via a speaker device. Moreover, the stores may use the display device to show merchandise information that is favored by the customer, relevant promotions, discount activities, and new arrivals information, etc. to cater for customer's pleasure and then to increase customer's desire and interest to buy the merchandises. And before showing merchandise advertising information, the system has sent out a voice media file of the corresponding greeting information to remind sales clerks to stop or finish the work on hand to receive customers. In addition, whenever the sales clerks are unable to stop the work, not well trained, or too green to answer or explain customers' questions, the customer may use the merchandise sensing device to sense a merchandise label, and the network server machine will search the corresponding data stored in the network server database with the sensed data and then output a corresponding marketing media file. The marketing media file will be played via the media playing device to solve the customers' queries; meanwhile, sales clerks may learn more knowledge and information about the merchandise so as to educate the sales clerks and increase their sales quality.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic diagram of a service system structure of the present invention;

FIG. 2 is a flow chart of a service method of the present invention; and

FIG. 3 is a schematic diagram for network connection of a service system of the present invention.

### DETAILED DESCRIPTION OF THE INVENTION

The features and practice of the present invention will be illustrated below in detail through preferred embodiments with reference to the accompanying drawings.

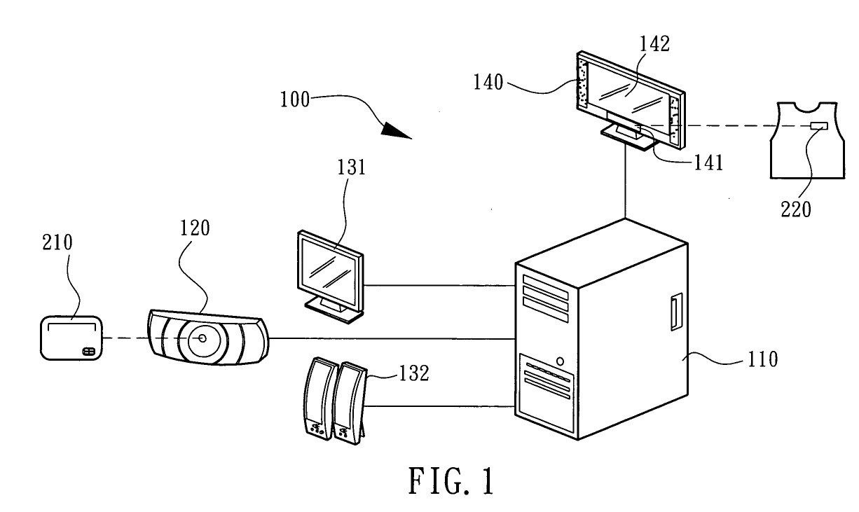

Please refer to FIG. 1, it is a schematic diagram of a service system structure of the present invention. A service system 100 comprises a network server machine 110, an ID sensing device 120, a display device 131, a speaker device 132, and a merchandise guide illustrating machine 140. The network server machine 110 comprises at least a network server database (not shown in FIG. 1) and the network server machine 110 is connected to the ID sensing device 120, the display device 131, the speaker device 132, and the merchandise guide illustrating machine 140, in which the merchandise guide illustrating machine 140 comprises a merchandise sensing device 141 and a media playing device 142.

The ID sensing device 120 is utilized to sense a customer ID card 210 and output the customer data of the customer ID card 210 to the network server machine 110. And the merchandise guide illustrating machine 140 is mainly using the merchandise sensing device 141 to sense a merchandise label 220 of merchandise and then outputting the merchandise data sensed from the merchandise label 220 to the network server machine 110.

When the network server machine 110 obtains the customer data, it will analyze the customer data and access the network server database to search the corresponding customer and consuming information. Then, according to the customer information, specific greeting information is searched and found from the network server database. Also, according to the consuming information, advertising information and a voice media file corresponding to the advertising information are found from the network server database accordingly. Furthermore, the display device 131 and the speaker device 132 are utilized to show the advertising information and to perform the voice media, respectively.

The advertising information is obtained by analyzing the successful transactions by the network server machine to get merchandise categories which are classified as number one, number two, or number three category, etc. by volume and then output new arrivals information, which is correspond to those classified merchandise categories, this new arrivals information is used to cater for customer's pleasure.

In addition, when the network server machine 110 obtains the merchandise data, the merchandise data are analyzed; meanwhile, a marketing media file corresponded to the merchandise data is opened from the network server database. The marketing media file is played by the media playing device 142 of the merchandise guide illustrating machine 140 to perform the marketing media. The marketing media file may be a picture medium, an image medium, a voice medium or a combination thereof. In addition to relevant merchandise information, the contents of the marketing media further comprise a collocation suggestion, mainly to introduce the merchandises that can be matched each other in the store. And the match effects are recorded in the marketing media file and can be presented by the media playing device 142 so as to let customers fully understanding the match effects and increase sales probability of other merchandises.

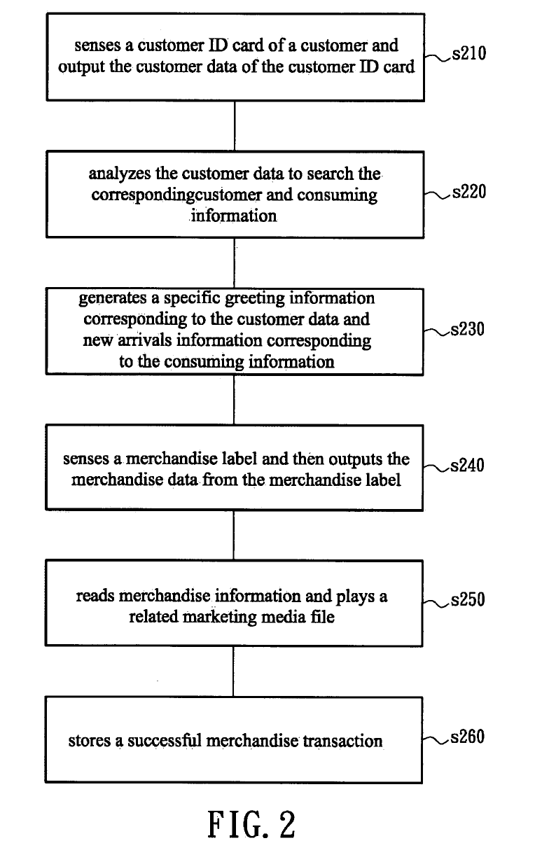

Please refer to FIG. 1 and FIG. 2, FIG. 2 is a flow chart of a service method of the present invention. The method of digital service includes the steps of following:

In the service method of the present invention, an ID sensing device 120 is utilized to sense a customer ID card 210 of a customer and output the customer data of the customer ID card to a network server machine 110 when the customer is close to the door of the store (Step s210). And the ID sensing device 120 may be installed on the door of store to avoid missing detection of the customer ID card 210 due to long distance between the ID sensing device 120 and the customer ID card 210. Besides, no matter the customer is inside or outside the door, the ID sensing device 120 can sense the customer ID card 210.

The network server machine 110 analyzes the customer data and compares with the customer and consuming information stored in the network server database to search the corresponding customer and consuming information (Step s220).

The network server machine 110 generates specific greeting information for the customer according to the customer data and then analyzes the successful transactions to get merchandise categories which are classified as number one, number two, or number three category, etc. by volume to generate the corresponding new arrivals information (Step s230). Eventually, the display device 131 is utilized to show the individual greeting and advertising information and the speaker device 132 is utilized to perform a voice medium corresponding to the greeting and advertising information.

In next step, the merchandise sensing device 141of the merchandise guide illustrating machine 140 is utilized to sense a merchandise label 220 of a merchandise for accessing the merchandise data, so as to output the merchandise data to the network server machine 110 (Step s240).

The network server machine 110 analyzes the merchandise data after obtaining and then compares the merchandise data with the data stored in the network server database. Next, in light of the comparison result, the network server machine 110 reads corresponding merchandise information, and then accesses a related marketing media file from the network server database. The media playing device is used to play the marketing media file afterwards (Step s250). The marketing media can be image media, voice media or the combination thereof. And the contents of the marketing media file also comprise the match effects of the merchandises matched with each other. Besides, the sales clerks can add additional information when the marketing media is playing or learn the relevant knowledge of merchandises from the marketing media.

The final step of the present invention is to store a successful merchandise transaction (Step s260). The network server machine 110 can use a casher machine (not shown in FIG. 1) to cooperate with the merchandise guide illustrating machine 140 to record a successful merchandise transaction, and then store the successful merchandise transaction into the network server database, so that the updated transaction can be analyzed by the network server machine 110 to obtain the merchandise category having the highest sales volume when the customer enters the store again and the newest merchandise information of that merchandise category can be provided to the customer therefore. In addition, when the customer enters any other stores installed with the service system of the present invention, the system can also show the customer's interest and demand to sales clerks, so that the sales clerks can offer a best service based on the information on the customer ID card.

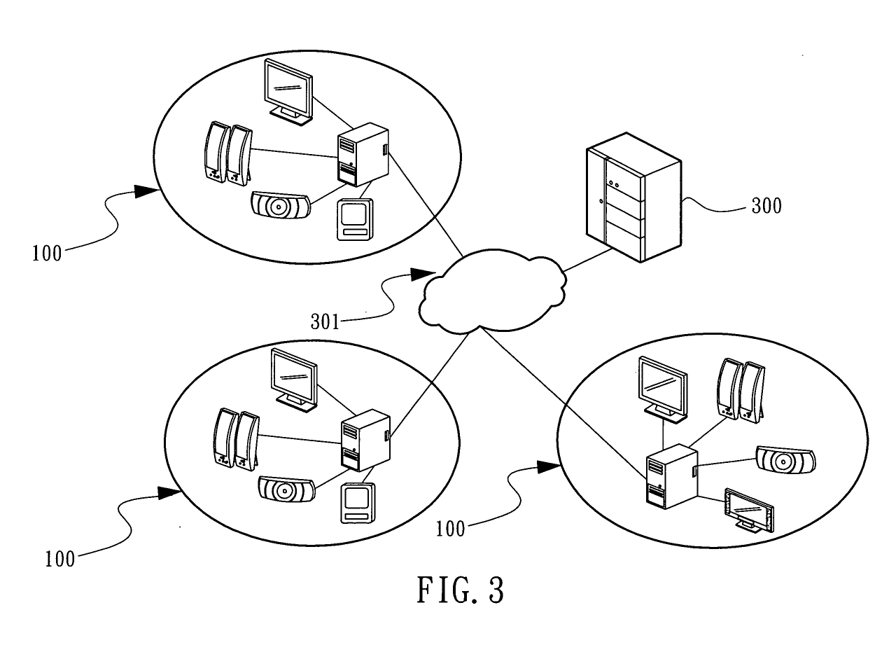

Please refer to FIG. 3, it is a schematic diagram for network connection of a service system of the present invention. The service system 100 of the present invention may be applied on network, mainly for chain stores. Each chain store has installed the service system 100 of the present invention, and then connects to each other via an internet 301. All customer consuming, merchandise, and related information are stored in the network server database of a central network server machine 300. The service system 100 of each chain store is connected to the central network server machine 300 via the respective network server machine 110 to access the information stored in the network server database so as to perform the digital customer service. Besides, when any network server machine 110 modifies or adds new marketing media files, other network server machines 110 of the service system 100 will update the data stored in its network server database automatically. In other words, the new customer information or transaction can be added in one service system, but the statistical analysis for providing suggestions can be performed in any other service system; meanwhile, the customer's identification can automatically be sensed and a specific greeting wording will be played to the customer.

As mentioned above, the method of digital service and system thereof of the present invention utilizes an ID sensing device to sense a customer ID card so as to perform greeting wording and favorite advertisements of merchandise to the customer by cooperating with a server machine and display devices; therefore, customer's purchasing desire can be increased. And a merchandise sensing device is utilized to sense a merchandise label, so as to perform a marketing media file by cooperating the server machine and media playing devices. The contents of the marketing media are related to the merchandise concerned by the customer and can provide the information of the merchandise to solve customers' queries and also provide sales clerks the opportunity to learn relevant knowledge. Moreover, the match effects of the merchandise with others are provided and relevant information of other merchandise is also provided indirectly, so that the sales probability of other merchandises can be raised at the same time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of digital customer service, comprising at least steps of following:
sensing a customer ID card and outputting customer data of the customer ID card;
analyzing the customer data to access corresponding customer information and corresponding consuming information;
outputting specific greeting information corresponding to the customer information and at least one advertising information corresponding to the consuming information;
sensing a merchandise label and outputting corresponding merchandise data; and
analyzing the merchandise data to obtain a corresponding marketing media file and playing the corresponding marketing media file.

2. The method of digital customer service as claimed in claim 1, further comprising a step of saving a successful transaction.

3. The method of digital customer service as claimed in claim 1, wherein the step of outputting specific greeting information corresponding to the customer information and at least one advertising information corresponding to the consuming information, comprising at least steps of following:
generating specific greeting information corresponding to the customer information;
generating an advertising information corresponding to the consuming information;
displaying the specific greeting information and the advertising information;
and
playing a voice media file of the specific greeting information and a voice media file of the advertising information.

4. The method of digital customer service as claimed in claim 1, wherein the step of analyzing the merchandise data to playing a corresponding marketing media file, comprising at least steps as following:
analyzing the merchandise data to access a corresponding merchandise information;
accessing a corresponding marketing media file according to the merchandise information; and
performing the marketing media file.

5. The method of digital customer service as claimed in claim 1, wherein marketing media of the marketing media file in the step of analyzing the merchandise data to obtain a corresponding marketing media file and playing the corresponding marketing media file is image media.

6. The method of digital customer service as claimed in claim 1, wherein marketing media of the marketing media file in the step of analyzing the merchandise data to obtain a corresponding marketing media file and playing the corresponding marketing media file is voice media.

7. A system of digital customer service, comprising:
an identification (ID) sensing device, for sensing a customer ID card and then output customer data of the customer ID card;
a merchandise sensing device, for sensing a merchandise label and output merchandise data of the merchandise label;
a network server machine comprising at least a network server database, the network server machine analyzing the customer data to access corresponding customer information and consuming information from the network server database and then outputting a specific greeting information corresponding to the customer information, at least one merchandise information corresponding to the consuming information, and a marketing media file corresponding to the merchandise data;
a display device, for accessing and displaying the specific greeting information and the merchandise information; and
a media playing device, for accessing and performing the marketing media file.

8. The system of digital customer service as claimed in claim 7, further including a speaker device, and the network server machine further outputting a voice media file corresponding to the specific greeting information and a voice media file corresponding to the merchandise information, the speaker device performing the voice media files.

9. The system of digital customer service as claimed in claim 7, wherein the network server machine analyzes the consuming information, so as to obtain a highest sales amount of merchandise category of successful transactions and output merchandise information corresponding to the merchandise category.

10. The system of digital customer service as claimed in claim 7, wherein the network server machine analyzes the consuming information, so as to obtain a highest and a second high sales amount of merchandise categories of successful transactions and output merchandise information corresponding to the merchandise categories.

11. The system of digital customer service as claimed in claim 7, wherein marketing media of the marketing media file is image media.

12. The system of digital customer service as claimed in claim 7, wherein marketing media of the marketing media file is voice media.
